(19) United States
(12) Patent Application Publication
(10) Pub. No.: US 2009/0042178 A1
(43) Pub. Date: Feb. 12, 2009

(54) Methods and systems for managing educational data

(76) Inventor: Shawn T. Bay, Fairfield, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/228,314

(22) Filed: Aug. 11, 2008

Related U.S. Application Data
(60) Provisional application No. 60/955,165, filed on Aug. 10, 2007.

(51) Int. Cl. G09B 7/00

(52) U.S. Cl. 434/350; 434/362

(57) ABSTRACT

Methods and systems for assigning a unique identifier to a student or staff member data record are disclosed. In some embodiments, the methods and systems include the following: receiving student or staff member data to develop a data record; validating the data; flagging data errors in the student or staff member data to create work assignments for correcting the data errors; identifying a worker or end user to complete the work assignment; routing the work assignment to the end user, wherein the end user is at one of the state, district, or school levels of an educational organization; limiting access of the end user to only those records within the educational organization that are required to complete the work assignment; completing the work assignment to correct the data errors in the student or staff member data record; and assigning a unique identifier to the student or staff member data record.

### BACKGROUND OF THE INVENTION

(1) Field of the Invention

The present invention generally relates to methods and systems for data management. In particular, the present invention is directed to methods and systems for managing educational data.

(2) Background

In prior educational data systems, various schemes are used to identify student and staff data. For example, in one system, each school, district, or region is provided a pool of identification numbers (IDs) to draw from. In another system, an ID is provided that derives from a student's or staff member's data, e.g., a combination of first initial, last name, and birth date. In other systems, a student's or staff member's social security number is used as a unique identifier.

Prior embodiments of the disclosed subject matter provide a way by which an education agency can assign unique identifiers to students and staff members. In prior embodiments, the following process flow was used to assign unique identifiers to students and staff members: 1) An end user submits certain data about the individual to whom a unique identifier is to be assigned. Some of the data is mandatory for the system to work. Other data is optional. Providing the optional data can assist the system in making a correct identifier assignment; 2) The data is validated to insure that all the required fields are present and they are in the correct format; 3) Data errors are flagged; 4) An end user fixes any and all data errors; 5) A matching engine attempts to find pre-existing identifiers. Outcome could be one matching person, no matching persons, or one or more near matching person(s); 6) End users manually resolve the near match outcomes; 7) Unique identifiers are assigned to data record; and 8) End users download all assigned identifiers in order to import them into their local data system.

Unlike some prior art systems, identifiers are not generated on the fly. Instead, identifiers are selected from a pool of identifiers that are pre-generated. When the application needs an identifier, it is taken from the pool. This insures that the identifier is unique and insures that identifiers do not repeat across multiple installations of the system. This is to make sure that the installation in one state has a different pool of identifiers than an installation in a second state.

In prior art systems, the selection of an end user during correction of data errors was not flexible. For example, a user at a state or district level was unable to forward an incorrect data record to an end user at a school for correction.

### SUMMARY OF THE INVENTION

One aspect of the invention is a method for assigning a unique identifier to a student or staff member data record. The method includes the following: receiving student or staff member data to develop a data record; validating the student or staff member data; flagging data errors in the student or staff member data to create a work assignment for correcting the data errors; identifying a worker or end user to complete the work assignment; routing the work assignment to the end user, wherein the end user is at one of the state, district, or school levels of an educational organization; limiting access of the end user to only those records within the educational organization that are required to complete the work assignment; completing the work assignment to correct the data errors in the student or staff member data record; and assigning a unique identifier to the student or staff member data record.

Another aspect of the invention is a system for assigning a unique identifier to a student or staff member data record. The system includes the following: a data intake module for receiving student or staff member data to develop a data record; a data validation module for validating the student or staff member data and flagging data errors to create a work assignment for correcting the data errors; a data correction module for identifying an end user to complete the work assignment, routing the work assignment to the end user, wherein the end user is at one of the state, district, or school levels of an educational organization, limiting access of the end user to only those records within the educational organization that are required to complete the work assignment, and completing the work assignment to correct the data errors in the student or staff member data record; and a data record identifier module for assigning a unique identifier to the student or staff member data record.

### BRIEF DESCRIPTION OF THE DRAWING

For the purpose of illustrating the invention, the drawing shows a form of the invention that is presently preferred. However, it should be understood that the present invention is not limited to the precise arrangements and instrumentalities shown in the drawing, wherein:

FIG. 1 is a flow diagram of methods and systems according to one embodiment of the disclosed subject matter.

### DETAILED DESCRIPTION

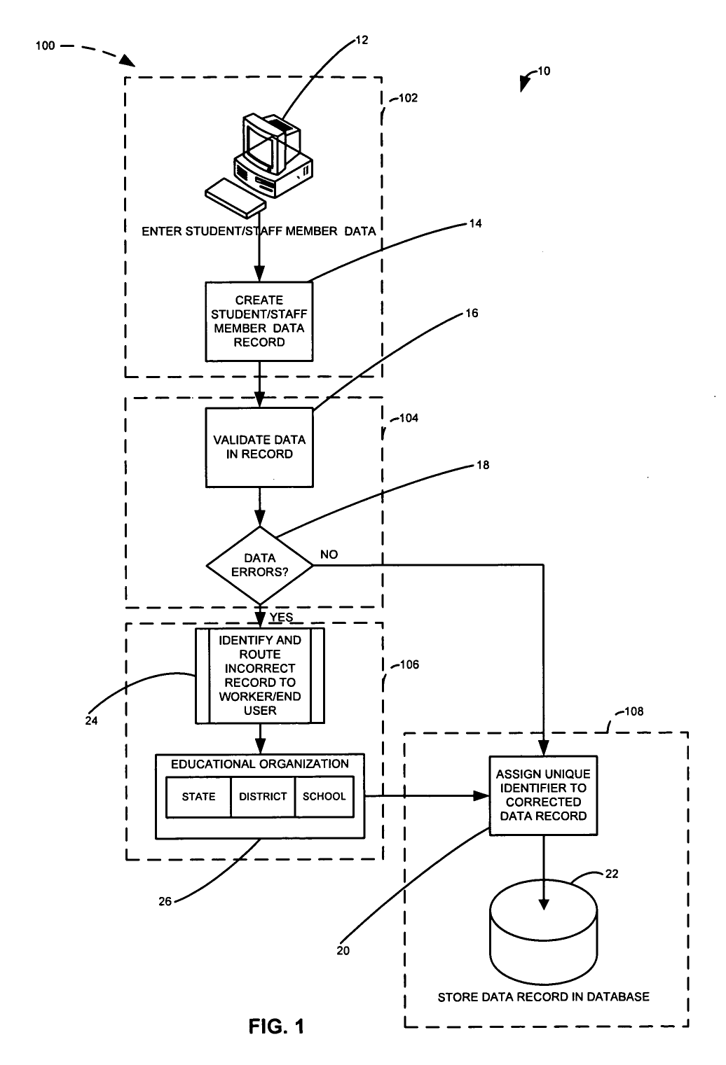

Referring now to FIG. 1, one aspect of the present invention is a method 10 for assigning a unique identifier to a student or staff member data record. In one embodiment, method 10 includes receiving student or staff member data, e.g., via data entry at 12 to develop a student or staff member data record at 14. At 16 and 18, the student or staff member data in the data record is validated to determine whether there are any errors in the data. If no data errors are detected, a unique identifier is assigned to the student or staff member data record at 20 and the data record is saved/stored in a database 22. If data errors are detected, at 24 and 26, a work assignment for correcting the data errors that have been flagged is routed to an appropriate worker/end user for completion of the work assignment or correction of the data. The end user can be at any one of the state, district, or school levels of an educational organization. In one embodiment, a work assignment is generated at a district level and the end user is at a school level. In other embodiments, work assignments may be generated at any one of the state, district, or school levels and the end user may also be at any one of the state, district, or school levels. When assigning a work assignment to an end user, the end user is only provided access to those records within the educational organization that are required to complete the work assignment. After the end user completes the work assignment thereby correcting the data errors in the student or staff member data record, at 20, a unique identifier is assigned to the data record and the record is stored in database 22.

In a broader view of the disclosed subject matter, a method for delegating work across a hierarchical organization is disclosed. The method includes receiving a work assignment at a first level of the hierarchical organization; identifying an end user to complete the work assignment; routing the work assignment to the end user, wherein the end user is in a different level of the hierarchical organization than the first level; and limiting access of the end user to only those records within the educational organization that are required to complete the work assignment.

Still referring to FIG. 1, another aspect of the disclosed subject matter is a system 100 for assigning a unique identifier to a student or staff member data record. System 100 includes a data intake module 102, a data validation module 104, a data correction module 106, and a data record identifier module 108. In data intake module 102, student or staff member data is received to develop a data record. In data validation module 104, the student or staff member data is validated and data errors are flagged to create a work assignment for correcting the data errors. In data correction module 106, an end user is identified to complete the work assignment and the work assignment is routed to the end user. The end user is at one of the state, district, or school levels of an educational organization and the end user is provided access to only those records within the educational organization that are required to complete the work assignment. Finally, in data correction module 106, the end user completes the work assignment to correct the data errors in the student or staff member data record. In data record identifier module 108, a unique identifier is assigned to the student or staff member data record and the record is saved to a database.

The invention provides a unique way in which to delegate the work needed to be done to get an identifier down to the parties who have the most knowledge. For example, in our system, someone at a district level can delegate work down to someone at a school level. Assume that there is a data error (an individual does not have a date of birth) that has to be fixed. Someone at a district level might not know the date of birth because they do not know the individual. However, someone at the school level does know the person and can provide that information. This process provides ways in which to delegate the responsibility of filling in that date of birth down to a school user.

The disclosed subject matter differs from prior versions in that work assignments can be delegated to any end users at any level of an organization. Previously, it was not possible to delegate work assignments downwardly from a high level to a low level within an organization, e.g., from the state or district level to the school level. One benefit of systems and methods according to the disclosed subject matter is that it will get the work into the hands of the users who have the required knowledge. As a result, it will lead to better data, which will lead to better business decision-making.

The basic user hierarchy of our system is: State User→District User→School User. The old process limited a user's ability to delegate work and handle other case management issues. As an example, let us assume that Bob works for the Allentown School District; Sally works for Lincoln High School; and Peter works for Washington High School. Both high schools are in the Allentown District. Assume that Bob submits a file to the system containing students/staff members from both high schools. At one step in the process, Bob discovers that a student/staff member from Lincoln HS is missing a Date of Birth. The old process would not allow Bob to delegate that work down to Sally. The only option Bob had was to repair the problem himself. This was not ideal since Sally and Peter would most likely have better knowledge of the students/staff members then would Bob.

The disclosed subject matter gives users a lot of flexibility as to whom they can assign work. Using the example above, assume Bob uploads a file containing students/staff members from both Lincoln HS and Washington HS. If Bob comes across the missing Date of Birth issue again, the system would automatically notify Sally of the missing value and allow her to repair the problem.

When prior systems and methods were created, it was not anticipated that a user at the district level would not have the knowledge of the students/staff members in a school in that district. The issue is especially significant in larger districts containing tens of thousands of students/staff members.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following claims.

What is claimed is:

1. A method for assigning a unique identifier to a student or staff member data record, said method comprising:
receiving student or staff member data to develop a data record;
validating said data;
flagging data errors in said student or staff member data to create a work assignment for correcting said data errors;
identifying an end user to complete said work assignment;
routing said work assignment to said end user, wherein said end user is at one of said state, district, or school levels of an educational organization;
limiting access of said end user to only those records within said educational organization that are required to complete said work assignment;
completing said work assignment to correct said data errors in said student data record; and
assigning a unique identifier to said student data record.

2. A method for delegating work across an educational organization, said method comprising:
receiving a work assignment at a state, district, or school level of the educational organization;
identifying an end user to complete said work assignment;
routing said work assignment to said end user, wherein said end user is at said state, district, or school level of the educational organization; and
limiting access of said end user to only those records within the educational organization that are required to complete said work assignment.

3. A method according to claim 1, wherein said work assignment is related to a student or staff member that is identified via a unique identifier code.

4. A method according to claim 1, wherein said work assignment is received at said district level and said end user is at said school level.

5. A method for delegating work across a hierarchical organization, said method comprising:
receiving a work assignment at a first level of the hierarchical organization;
identifying an end user to complete said work assignment;
routing said work assignment to said end user, wherein said end user is in a different level of the hierarchical organization than said first level; and
limiting access of said end user to only those records within the educational organization that are required to complete said work assignment.

6. A system for assigning a unique identifier to a student or staff member data record, said system comprising:
a data intake module for receiving student or staff member data to develop a data record;
a data validation module for validating said student or staff member data and flagging data errors to create a work assignment for correcting said data errors;
a data correction module for identifying an end user to complete said work assignment, routing said work assignment to said end user, wherein said end user is at one of said state, district, or school levels of an educational organization, limiting access of said end user to only those records within said educational organization that are required to complete said work assignment, and completing said work assignment to correct said data errors in said student or staff member data record; and
a data record identifier module for assigning a unique identifier to said student or staff member data record.
